(19) United States
(12) Patent Application Publication
(10) Pub. No.: US 2026/0119894 A1
(43) Pub. Date: Apr. 30, 2026

(54) SYNTHETIC CONVERSATION GENERATION FOR GENERATIVE ARTIFICIAL INTELLIGENCE MODEL TUNING

(71) Applicant: Salesforce, Inc., San Francisco, CA (US)

(72) Inventors: Kiran Ramnath, San Francisco, CA (US); Regunathan Radhakrishnan, San Francisco, CA (US); Shiva Kumar Pentyala, San Francisco, CA (US); Sitaram Asur, San Francisco, CA (US)

(21) Appl. No.: 18/927,209

(22) Filed: Oct. 25, 2024

(51) Int. Cl. G06N 3/091; G06N 3/045

(52) U.S. Cl. CPC G06N 3/091; G06N 3/045

(57) ABSTRACT

A system may receive first reference information. The system may generate synthetic conversation records using a first generative artificial intelligence (AI) model. The system may generate response pairs based on the synthetic conversation records, where each response pair includes a respective positive response in accordance with the first reference information and a respective negative response in disaccord with the first reference information. The system may train a first set of generative AI parameters based on the plurality of response pairs and may merge the first set of generative AI parameters with a second set of generative AI parameters to generate a merged set of parameters. The system may receive a query and may provide a response generated by generative AI based on the merged set of parameters.

### FIELD OF TECHNOLOGY

The present disclosure relates generally to database systems and data processing, and more specifically to synthetic conversation generation for generative artificial intelligence model tuning.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may employ retrieval augmented generation (RAG) techniques. However, such methods may be improved.

### BRIEF DESCRIPTION OF THE DRAWINGS

FIG. 1 illustrates an example of a data processing system that supports synthetic conversation generation for generative artificial intelligence model tuning in accordance with examples as disclosed herein.

FIG. 2 shows an example of a system that supports synthetic conversation generation for generative artificial intelligence model tuning in accordance with examples as disclosed herein.

FIG. 3 shows an example of a training scheme that supports synthetic conversation generation for generative artificial intelligence model tuning in accordance with examples as disclosed herein.

FIG. 4 shows an example of a response scheme that supports synthetic conversation generation for generative artificial intelligence model tuning in accordance with examples as disclosed herein.

FIG. 5 shows an example of a process flow that supports synthetic conversation generation for generative artificial intelligence model tuning in accordance with examples as disclosed herein.

FIG. 6 shows a block diagram of an apparatus that supports synthetic conversation generation for generative artificial intelligence model tuning in accordance with examples as disclosed herein.

FIG. 7 shows a block diagram of a synthetic conversation manager that supports synthetic conversation generation for generative artificial intelligence model tuning in accordance with examples as disclosed herein.

FIG. 8 shows a diagram of a system including a device that supports synthetic conversation generation for generative artificial intelligence model tuning in accordance with examples as disclosed herein.

FIG. 9 shows a flowchart illustrating methods that support synthetic conversation generation for generative artificial intelligence model tuning in accordance with examples as disclosed herein.

### DETAILED DESCRIPTION

While generative artificial intelligence (AI) models perform well at world knowledge, problem solving, and generating coherent conversational replies, they often fall short in some task specifications and domain considerations. Retrieval Augmented Generation (RAG) is one approach to improve the operation of generative AI models, but it has its own limitations. For example, generative AI models may not be tuned to be retrieval aware, generation accuracy is bottlenecked by the quality of the retriever, and generative AI models are limited by the quantity of tokens that they may process. Such limitations may be addressed by using parameter efficient fine tuning (PEFT) techniques or reinforcement learning from human feedback (RLHF) techniques. Such techniques may employ expert-preference data to better train the generative AI model. However, obtaining such information is often prohibitively expensive or such information may not exist.

The techniques described herein include generation (e.g., using a generative AI model) of synthetic conversations that are based on tenant-specific knowledge documents (e.g., reference articles, conversation templates, response templates, or other knowledge documents). These synthetic conversations may include (e.g., either explicitly or implicitly) references to or information from the tenant-specific knowledge (e.g., that is used to answer a hypothetical query). These synthetic conversations or portions thereof may be used to generate one or more “positive” responses to be used in creating sets of positive-negative responses that are to be included in the RLHF data (e.g., in a tenant-specific “adapter”) that is used to fine-tune the generative AI models through the use of low rank adaptation (LoRA) processing of the RLHF data and the generative AI model (e.g., in which a small portion of the parameters of the generative AI model are updated or modified based on the tenant-specific adapter). In some examples, if it is available, real conversations may also be used to generate both positive and negative responses to be included in the RLHF data. In some examples, the synthetic conversations may be generated to intentionally create a negative responses (e.g., that does not correctly answer the synthetic query) so as to provide negative responses for the positive-negative response pairs.

Aspects of the disclosure are initially described in the context of an environment supporting an on-demand database service. Aspects of the disclosure are then described with reference to a system, a training scheme, a response scheme, and a process flow. Aspects of the disclosure are further illustrated by and described with reference to apparatus diagrams, system diagrams, and flowcharts that relate to synthetic conversation generation for generative artificial intelligence model tuning.

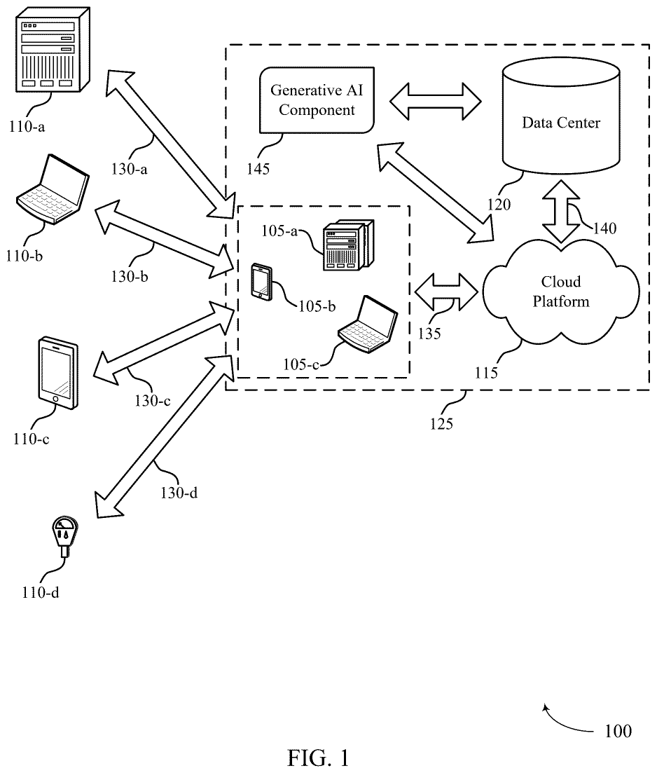

FIG. 1 illustrates an example of a system 100 for cloud computing that supports synthetic conversation generation for generative artificial intelligence model tuning in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a large language model (generative AI model), such as the generative AI component 145. In some examples, a generative AI component 145 may also be referred to as any of an artificial intelligence (AI), a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

For example, an administrator associated with the cloud platform 115 or the cloud client 105 may provide knowledge base information (e.g., articles, conversation snippets, conversation templates, or other information associated with the tenant) to the generative AI component 145, which may generate synthetic conversations that may be “positive” or “negative” conversations, in that the conversations may be “positive” examples (e.g., correctly retrieving or utilizing information from the knowledge base information) or “negative” examples (examples of incorrectly retrieving or utilizing information from the knowledge base information). These positive and negative examples may be used to perform LoRA techniques to further train the generative AI model for subject matter, domains, tenants, or other specializations that are not available for general-purpose generative AI models.

Existing approaches to the use of RAG for generative AI models may not be retrieval aware and the quality of generated responses may be dependent on the quality of the retriever. However, to have a high quality retrieval system, it may be desirable to have a high quality or relevant data to be retrieved to augment the generative AI model response generation. However, in many contexts such data may not be available or may be prohibitively expensive to obtain.

The techniques described herein may involve generation of “synthetic” conversations using generative AI models to provide data that may be used for RAG techniques. For example, the generative AI model may generate examples of “positive” responses that do include information relevant or associated with a topic, examples of “negative” responses that are not relevant or associated with a topic, or both. Such positive-negative response pairs may be used for training or modification of generative AI models (e.g., via LoRA processing) for different tenants (e.g., via the use of tenant-specific “adapters” that include merged data from a base generative AI model and the positive-negative response pairs (or data derived therefrom).

In at least these ways, such techniques may provide tenant-specific finetuning frameworks that can be scaled across tasks and domains. Such finetuning techniques may function equally well with data from different source entities. Additionally, or alternatively, the techniques described herein also include a labelled data generation framework that can be used to obtain preference data through feedback that can be explicit, implicit, or even synthetic, thus avoiding the expensive manual labelling problem. Additionally, or alternatively, the techniques described herein may involve generating off-policy supervision using explicit and implicit attaches for “winning” or preferred pairs. The techniques described herein may circumvent operations involving sampling several candidate generations from a generative AI model per query, instead considering past attaches directly as winning candidates and may further include performing an offline automated retrieval to generate pseudo-negatives (e.g., dispreferred generations). Additionally, or alternatively, the techniques described herein may further involve an option to serve a finetuned generative AI model either in a RAG approach or directly generating responses. In some examples, side stepping RAG techniques may offer latency and cost benefits (e.g., a reduction in latency, cost, or both).

For example, an administrator associated with a tenant may provide knowledge base material (e.g., knowledge articles, communication templates, response templates, or other information associated with the tenant) to a generative AI model to generate synthetic conversations that may include “positive” examples that correctly incorporate information from the knowledge base material, “negative” examples that incorrectly incorporate (or fail to incorporate) information from the knowledge base material. These positive-negative pairs may be used as data to train the generative AI model to promote improved responses that are better suited to the domain and knowledge associated with the tenant.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

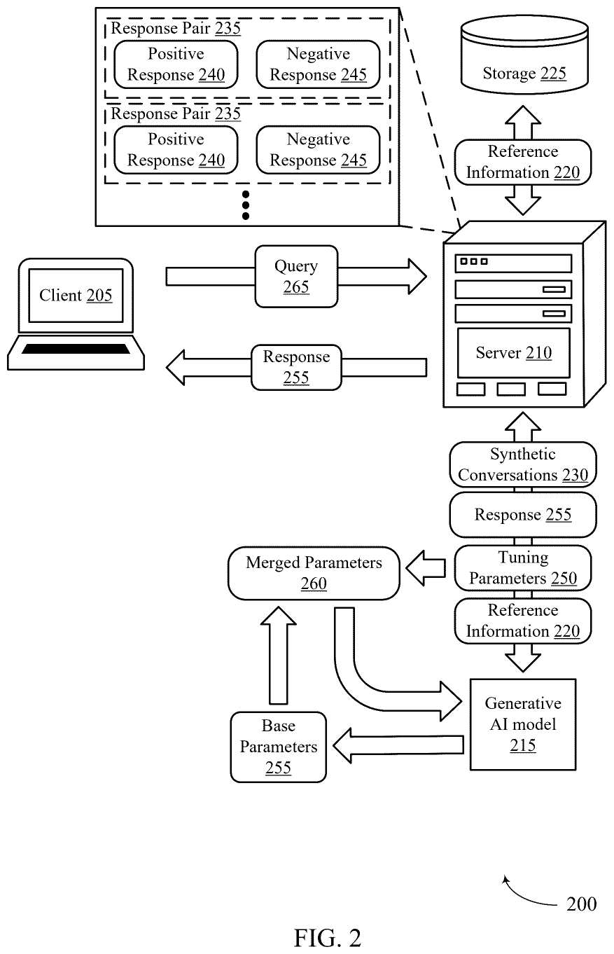

FIG. 2 shows an example of a system 200 that supports synthetic conversation generation for generative artificial intelligence model tuning in accordance with examples as disclosed herein. The system 200 may include a client 205, a server 210, and a generative AI model 215. The server 210 may represent a single server or processing entity, multiple servers or processing entities, a complete processing system, or any other entity capable of performing the operations described herein. The generative AI model 215 may be included as part of or otherwise associated with the server 210 or may operate independently of the server 210. The generative AI model 215 may represent a single generative AI model or multiple generative AI models.

While generative AI models perform well for general world knowledge, problem solving, and generating coherent conversational replies, they may fall short of some task specifications and domain considerations. In some examples, RAG may be employed in efforts to overcome these issues, but RAG also includes some challenges. For example, generative AI models may not be tuned to be retrieval aware, as generative AI models are generally not trained to work with complex prompt-structures deployed in production that contain several instructions, task-specification, and complex retrieved chunks. Additionally, or alternatively, accuracy may be bottlenecked by the quality of the RAG retriever. For example, if the retrieved documents are not sufficient (e.g., include incomplete or irrelevant information), the RAG techniques may struggle to leverage another knowledge base to overcome the deficiencies. Additionally, or alternatively, the generative AI model may be limited by the quantity of tokens it can process in each turn. For example, it may not be possible to feed in an entire knowledge base of an organization in the context of each reply in a conversation.

In some cases, such considerations for RAG may be improved by finetuning an generative AI model using parameter efficient finetuning (PEFT) methods. However, finetuning a generative AI model using RLHF techniques has previously involved expert preference data, and manually obtaining this instruction dataset for each customer may be prohibitively expensive. In some examples, such preference data may be either a ranking of N candidate generations per prompt or simply two candidates with one winning and one losing candidate.

In some examples, workarounds such as aggregating datasets across tenants or transferring learned weights across tenants may be employed, but may not be appropriate in many contexts due to security and privacy concerns.

To overcome such technical problems, the techniques described herein involving harvesting past conversations within a tenant to generate such supervision trivially. For example, such a system may selectively filter agent utterances that are deemed to be “attaches” (e.g., inclusions of information) from existing knowledge bases. Such “attaches” may be categorized into multiple categories, such as explicit, implicit, or synthetic attaches. An explicit attach may involve exact or near exact language from a knowledge base being employed. An implicit attach may involve the use of the same ideas or content from a knowledge base but with different language to express the ideas or content. Synthetic attaches may involve the use of a generative AI model to generate synthetic conversations that include either explicit or implicit attaches in the synthetic or generated conversations.

The benefits of employing such techniques are multi-fold. For example, such technique may allow for transfer learning, where a generative AI model finetuned according to the techniques described herein may also be used to augment other generative AI model use cases such as case summarization, knowledge creation, or other techniques for a given tenant as a result of the generative AI model being trained with the tenant-specific knowledge and jargon. Additionally, or alternatively, latency and costs may be reduced due to the use of an in-house model. Additionally, or alternatively, control may be improved, as it may be easier (e.g., as compared to other approaches) to control model performance in specific aspects such as trust, privacy, security, bias, fairness, or other considerations that are involved in the use of generative AI models. Additionally, or alternatively, the techniques described herein may improve or avoid “cold start” problems for finetuning (e.g., in which there may be a lack of data before a feature is available) by harvesting some or all existing data associated with the tenant (e.g., past chat transcripts, knowledge articles, template replies, synthetic data or conversations, other tenant-associated information, or any combination thereof). Additionally, or alternatively, the techniques described herein may allow for improved onboarding of new agents by cross-pollination of institutional knowledge from experienced service agents to newer service agents, thereby preserving company-specific knowledge and brand-voice, among other characteristics.

For example, a system may access the reference information 220 that may be information associated with a tenant, customer, organization, or other entity that may be associated with the use of the system. For example, such reference information 220 may be associated with a plurality of users of the organization or entity. In some examples, the client 205 may provide the reference information to the client 205 or the server 210 may retrieve the reference information 220 from the storage 225.

Based on this reference information 220, the system may generate (e.g., via the generative AI model 215) one or more synthetic conversations 230. These synthetic conversations 230 may be generated conversations that may include or indicate information from the reference information 220 or may purposefully exclude or incorrectly provide information from the reference information 220.

Based on the synthetic conversations 230, the system may generate a plurality of response pairs 235. These response pairs 235 may include both one or more positive responses 240 and one or more negative responses 245. A positive response 240 may include conversation information that directly includes or indicates information from the reference information 220 in a correct or accurate manner, such as being relevant to an associated conversation situation or context. A negative response 245 may include information that is incorrect or inapplicable to a conversation situation or context or may outright fail to include conversation information that directly includes or indicates information from the reference information 220. In some examples, the prompt provided to the generative AI model 215 to generate the synthetic conversations 230 may indicate that the generative AI model 215 is to generate relevant, correct information, intentionally generate irrelevant or incorrect information, or both. Both kinds of information included in the synthetic conversations 230 are useful for training the generative AI model 215.

In some examples, the system may use the response pairs 235 to generate tuning parameters 250 that are to be merged with the base parameters 255 of the generative AI model 215. For example, in some cases, the tuning parameters 250 may be the response pairs 235, or the tuning parameters 250 may be parameters that are generated based on the response pairs 235. In either case, such merging may generate or produce the merged parameters 260. In some examples, the base parameters 255 may be parameters that are included in the generative AI model 215 before additional training or modifications, and may be parameters that are generally applicable or of general scope for the operation of the generative AI model 215. In some examples, the merging of the tuning parameters 250 and the base parameters 255 may be achieved through LoRA techniques, through which the generative AI model 215 may be trained based on the merged parameters 260, allowing the generative AI model 215 to provide responses to queries that leverage the reference information 220 from the tenant, organization, or entity.

One or more elements of the system 200 may be deployed for operation for the tenant. In some examples, as part of such operation, the server 210 may receive a query 265 from the client 205, which may include a request to answer a question, produce information, or otherwise employ the generative AI model 215 to produce a response 270 to the query 265. In some examples, the client 205 may be associated with a user that is associated with the tenant, organization, or entity.

In some examples, the server 210 may pass the query 265 to the generative AI model 215, which may generate the response 270 (e.g., based on the merged parameters 260) and the server 210 may provide the response 270 to the client 205.

In at least this way, the system 200 may allow for tenant-specific (or organization-or entity-specific) training of the generative AI model 215 using synthetic conversation information generated by the generative AI model 215.

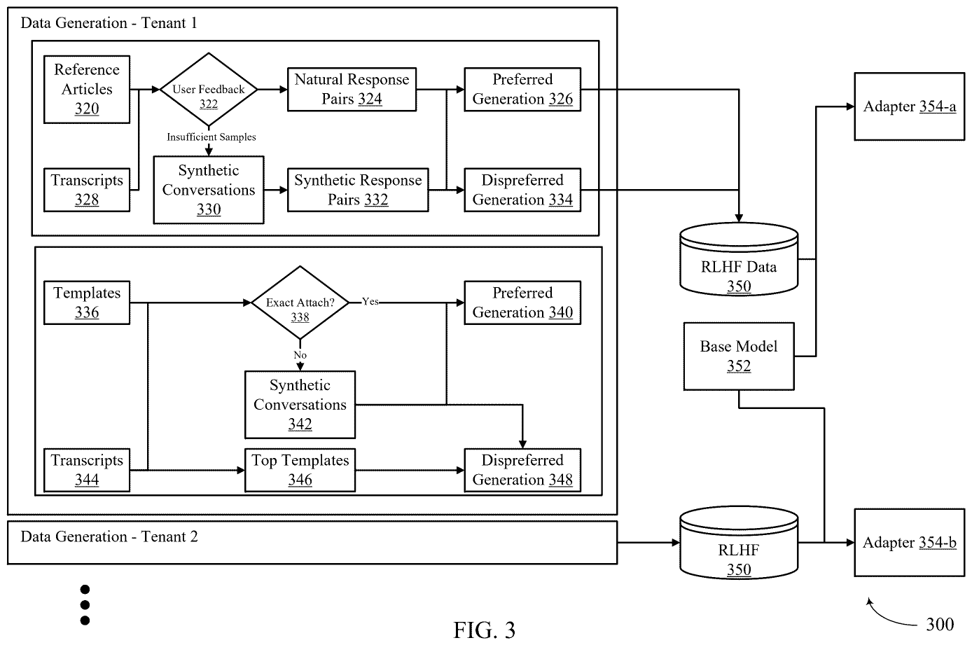

FIG. 3 shows an example of a training scheme 300 that supports synthetic conversation generation for generative artificial intelligence model tuning in accordance with examples as disclosed herein.

The training scheme 300 may describe or include techniques for generating the adapters 354 on a per-tenant (or per-organization or per-entity) basis using reference information that is associated with the tenant. For example, the adapter 354-a may be associated with tenant 1 and the adapter 354-b may be associated with tenant 2, and so on for any quantity of tenants and adapters 354. Such reference information may include any type of information associated with the tenant. Though examples of the reference articles 320 and the templates 336 are included here, any type of information may be used for the techniques described herein.

The training scheme 300 may include techniques for tenant-specific fine-tuning of generative AI models, such as through parameter efficient finetuning (PEFT) methods, including LoRA methods, which may result in the generation of the adapters 354. The adapters 354 may include parameters that may be merged with base parameters of the base model 352 (e.g., a base generative AI model). Such merging may be performed on a per-tenant basis and the parameters to be merged with the base parameters of the base model 352 may be different for each tenant.

In some examples, finetuning the base model 352 through reinforcement algorithms (e.g., direct preference modification) may involve two samples per response, such as a preferred generation and a dispreferred generation, which may be referred to as a preferred generation 326 and a dispreferred generation 334 or a preferred generation 340 and a dispreferred generation 348. These response or response pairs may be stored or processed as the RHLF data 350, which may be used to generate tenant-specific parameters that may be merged with parameters of the base model 352 to generate the tenant-specific adapters 354.

In the training scheme 300, techniques are described with relation to the reference articles 320 and the templates 336. However, the techniques may be applied to any type of information that is desirable to use for training a generative AI model.

For generation involving the reference articles 320, it may be desirable to generate positive-negative pairs of responses (e.g., pairings of a preferred generation 326 and a dispreferred generation 334) for a same conversation query. The conversation query may be either a real or hypothetical query that was actually or could possibly be received by a system utilizing the generative AI model. Such pairings may be generated based on real, archived conversations or synthetically-generated conversations (e.g., generated by a generative AI model in accordance with techniques described herein).

For example, the reference articles 320, the transcripts 328, or both, may be analyzed to determine user feedback on the transcripts 328 of actual chat interactions. In some examples, such review may be performed by the generative AI model, where a prompt may be provided instructing the generative AI model to analyze the transcript 328 and the reference articles 320 to determine whether one or more portions of the transcript 328 are positive, helpful responses or negative, unhelpful responses. Additionally, or alternatively, such analysis may be obtained from user feedback records or other feedback records.

In some examples, the user feedback 322 may not include sufficient feedback records (e.g., may fall short of a threshold quantity of feedback records). In such cases, a generative AI model may be employed to generate the synthetic conversations 330, which may intentionally include positive responses or interactions that include or indicate information from the reference articles, negative responses or interactions that do not include or indicate information from the reference articles 320 (or include incorrect information), or both. Such synthetic conversations 330 may be analyzed, parsed, or otherwise processed to extract or generate synthetic response pairs 332.

Additionally, or alternatively, the user feedback 322 may include some feedback records. Independent of whether the synthetic conversations 330 and the synthetic response pairs 332 are generated, the user feedback 322 may be employed to generate natural response pairs 324. For example, the user feedback 322 may indicate one or more portions of the transcripts 328 that may include a preferred generation 326 or a dispreferred generation 334.

In some examples, a conversation (be it a synthetic conversation 330 or a natural conversation) that explicitly refers to or includes a portion of the reference articles 320 may be said to have an explicit attach. An implicit attach may be a situation in which the conversation correctly discusses or refers to the subject matter of the reference article 320 without explicitly including the language included in the reference article 320, for example.

In some examples, a preferred generation 326 associated with an explicit attach may include or be associated with one or more conversation snippets or elements, one or more elements of a reference article 320 (e.g., a “chunk” of a reference article 320 or other reference information) referred to in the conversation snippets or elements, one or more response pairs (e.g., a pair of the preferred generation 326 and the dispreferred generation 334), or any combination thereof, that were posted as-is or edited by a human in a natural conversation.

In some examples, a dispreferred generation 334 associated with an explicit attach may include or be associated with one or more conversation snippets or elements, but these conversation snippets or elements may be associated with portions of a reference article 320 that was not used in a natural conversation or marked as dispreferred in the user feedback 322.

In some examples, a synthetic attach may be a situation in which a synthetic conversation 330 includes a reference to or language included in the reference article 320. In some examples, if a natural conversation from a reference article 320 does not contain an explicit attach, the generative AI model may be prompted to generate a synthetic conversation 330 in which a chunk from the reference article 320 (e.g., a chunk that is not included in a preferred generation 326 or is not associated with an explicit attach in a natural conversation) may be included. From this synthetic conversation 330, a preferred generation 326 may be derived. Similarly, the generative AI model may be prompted to intentionally produce a synthetic conversation 330 in which no attach is included or an erroneous attach is included, thereby providing an example for a dispreferred generation 334. In some examples, such a dispreferred generation 334 may be associated with a response (e.g., either real or synthetic) that is devoid of a chunk of a reference article 320 or includes an erroneous or irrelevant chunk of a reference article 320.

Similarly, generation of RLHF data 350 may be performed based on one or more templates 336. The template 336 may include or indicate conversation snippets, sentences, phrases, paragraphs, quick text, or other templates that may be used for rapid inclusion in conversations. Such templates 336 may include approved language or language that include placeholders that may be dynamically filled at runtime.

Similar to data generation associated with the reference articles 320, the goal of data generation associated with the templates 336 is to generate positive and negative pairs (e.g., a pair of a preferred generation 340 and a dispreferred generation 348) for a same conversation query.

In some examples, such as at 338, it may be determined whether the template 336 includes an explicit attach or not. If so, the portion of the transcript 344 with the explicit attach, the associated template 336, or any combination thereof, may be included or indicated in a preferred generation 340 or a dispreferred generation 348.

In some examples, an explicit attach may be an explicit mention or inclusion of a given template 336 in a transcript 344 (e.g., a natural conversation). In some examples, a preferred generation 340 may include or indicate a portion of the transcript 344 in which a template 336 was used, which may be an example of an explicit attach. Similarly, a dispreferred generation 348 may include a portion of a transcript 344 where template language was used, but the template language is not the same as language found in the template 336.

In some examples, an analysis may be performed of multiple templates 336. If an exact attach is not found for a given template 336 or portion thereof, the generative AI model may generate one or more synthetic conversations 342 that may indicate or include the template 336 to provide one or more preferred generations 340, one or more dispreferred generations 348, or both. In such cases, the inclusion (or non-inclusion or erroneous inclusion) of the template 336 in the synthetic conversations 342 may be termed a synthetic attach (or a non-attach, in the case of non-inclusion or erroneous inclusion). In some examples, the generative AI model may intentionally generate a non-inclusion or erroneous inclusion of the template 336 in the synthetic conversations 342 to aid in producing a dispreferred generation 348.

In the context of generative AI model generation of the synthetic conversations 342, a preferred generation 340 may include a generated conversation that includes the language of the template 336. Further, a dispreferred generation 348 may employ template language that is different than the template 336 (e.g., the generated conversation includes erroneous information or fails to include one or more pieces of information). In some examples, one or more top templates 346 may be one or more template 346 that have been analyzed or rated to provide information to be included in the preferred generations 340, dispreferred generations 348, or both.

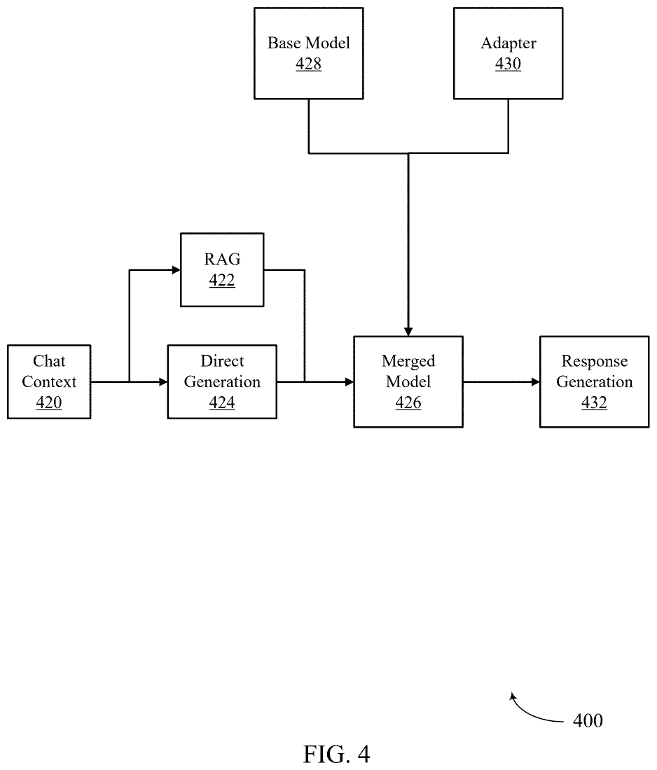

FIG. 4 shows an example of a response scheme 400 that supports synthetic conversation generation for generative artificial intelligence model tuning in accordance with examples as disclosed herein.

The response scheme 400 may describe techniques for online response generation using both a base model 428 and an adapter 430, which may be a tenant-specific adapter.

In the response scheme 400, given a current chat context 420, the system may employ the use of a generative AI model (e.g., the base model 428 or the merged model 426) to generate one or more responses to one or more queries from a client.

In some examples, the system may determine whether to perform the RAG 422 or to perform the direct generation 424. In the RAG 422, for each query, the system may retrieve possible candidates upon which the response may be based. Additionally, or alternatively, in the direct generation 424, the system may directly generate the output without performing the RAG 422. In either case, the adapter 4330 that was finetuned on the tenant's specific conversations, knowledge base, articles, templates, or other tenant-associated information, the direct generation may be employed, and may, in some cases, involve reduced latency due to avoiding any bottlenecks that may be associated with the RAG 422.

In either case (e.g., involving the RAG 422 or the direct generation 424) the adapter 430 for the tenant may be merged with the base model 428 (e.g., parameters associated with the adapter 430 may be merged with parameters of the base model 428, such as via LoRA or PEFT techniques). Such merging may generate or otherwise result in the merged model 426, which may perform the response generation 432, which may involve generative AI model processing of the query to generate the response.

In at least these ways, a generative AI model may utilize the tenant-specific or tenant-associated information to respond to the query, thereby improving RAG techniques and overcoming obstacles with generative AI model usage, particularly when domain-specific knowledge is desirable while still maintaining security and isolation considerations between different tenants.

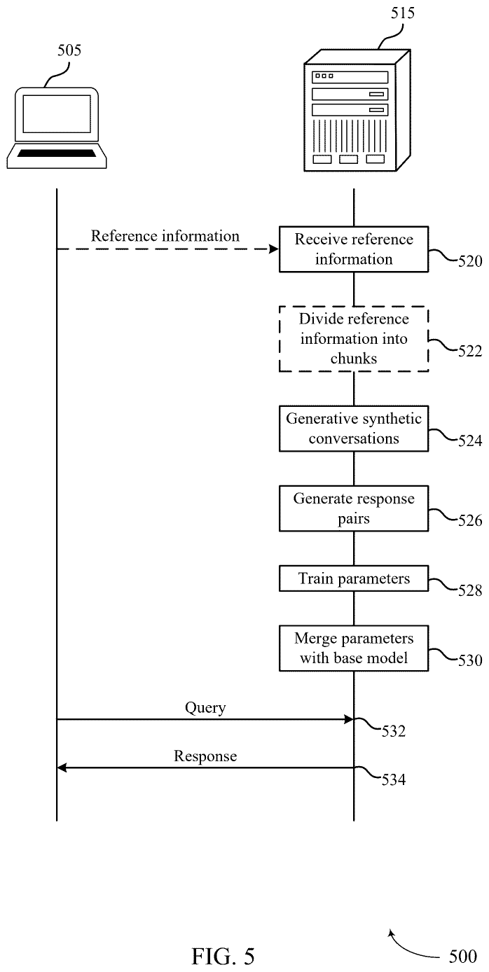

FIG. 5 shows an example of a process flow 500 that supports synthetic conversation generation for generative artificial intelligence model tuning in accordance with examples as disclosed herein.

The process flow 500 may implement various aspects of the present disclosure described herein. The elements described in the process flow 500 (e.g., server 515 and client 505) may be examples of similarly named elements described herein.

In the following description of the process flow 500, the operations between the various entities or elements may be performed in different orders or at different times. Some operations may also be left out of the process flow 500, or other operations may be added.

Although the various entities or elements are shown performing the operations of the process flow 500, some aspects of some operations may also be performed by other entities or elements of the process flow 500 or by entities or elements that are not depicted in the process flow, or any combination thereof.

At 520, the server 515 may receive first reference information associated with a plurality of users. In some examples, the first reference information may include reference articles, chat template responses, chat transcripts, or any combination thereof. In some examples, the plurality of users are associated with a tenant of a multi-tenant processing system.

At 522, the server 515 may divide the first reference information into one or more chunks and generating the one or more synthetic conversation records may include providing the one or more chunks of the first reference information to the first generative AI model.

At 524, the server 515 may generate, using a first generative artificial intelligence (AI) model and based on the first reference information, one or more synthetic conversation records. In some examples, to generate the one or more synthetic conversation records, the server 515 may provide a prompt requesting generation of the one or more synthetic conversation records to include one or more positive responses that are in accordance with the first reference information, one or more negative responses that are in conflict with the first reference information, or both. In some examples, the one or more synthetic conversation records comprise the one or more positive responses, the one or more negative responses, or both.

At 526, the server 515 may generate a plurality of response pairs based on the one or more synthetic conversation records, each response pair of the plurality of response pairs that may include a respective positive response that is in accordance with the first reference information and a respective negative response that is in disaccord with the first reference information. In some examples, to generate the plurality of response pairs, the server 515 may analyze the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information and the plurality of response pairs comprise information from the one or more first portions. In some examples, the correspondences between the one or more first portions and the one or more second portions comprise explicit correspondences in which first language in the one or more first portions is also comprised in the one or more second portions, implicit correspondences in which second language in the one or more first portions refers to third language in the one or more second portions, or both. In some examples, generating the plurality of response pairs is further based on one or more natural conversation records, feedback information associated with the one or more natural conversation records, or both.

At 528, the server 515 may train a first set of parameters of a second generative AI model based on the plurality of response pairs.

At 530, the server 515 may merge the first set of parameters of the second generative AI model with a second set of parameters associated with a base model of the second generative AI model to generate a merged set of parameters. In some examples, to merge the first set of parameters with the second set of parameters, the server 515 may apply a weight update to the second set of parameters of the second generative AI model and the weight update is based on the first set of parameters. In some examples, the first generative AI model and the second generative AI model are a same generative AI model.

At 532, the server 515 may receive a query from a user of the plurality of users.

At 534, the server 515 may provide, to the user, a response generated by the second generative AI model based on the merged set of parameters of the second generative AI model.

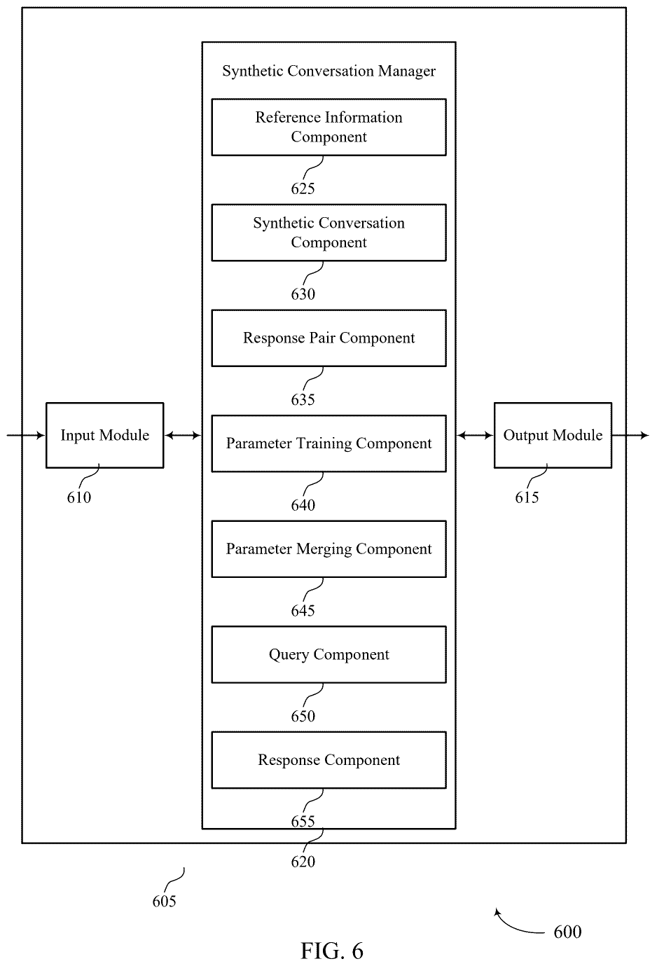

FIG. 6 shows a block diagram 600 of a device 605 that supports synthetic conversation generation for generative artificial intelligence model tuning in accordance with examples as disclosed herein. The device 605 may include an input module 610, an output module 615, and a synthetic conversation manager 620. The device 605, or one or more components of the device 605 (e.g., the input module 610, the output module 615, the synthetic conversation manager 620), may include at least one processor, which may be coupled with at least one memory, to support the described techniques. Each of these components may be in communication with one another (e.g., via one or more buses).

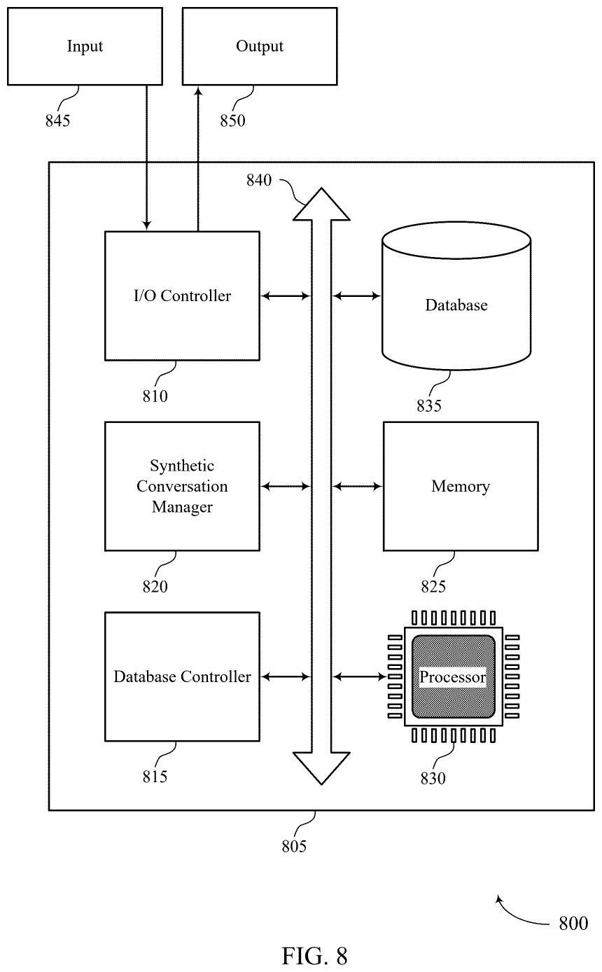

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the synthetic conversation manager 620 to support synthetic conversation generation for generative artificial intelligence model tuning. In some cases, the input module 610 may be a component of an input/output (I/O) controller 810 as described with reference to FIG. 8.

The output module 615 may manage output signals for the device 605. For example, the output module 615 may receive signals from other components of the device 605, such as the synthetic conversation manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the synthetic conversation manager 620 may include a reference information component 625, a synthetic conversation component 630, a response pair component 635, a parameter training component 640, a parameter merging component 645, a query component 650, a response component 655, or any combination thereof. In some examples, the synthetic conversation manager 620, or various components thereof, may be configured to perform various operations (e.g., receiving, monitoring, transmitting) using or otherwise in cooperation with the input module 610, the output module 615, or both. For example, the synthetic conversation manager 620 may receive information from the input module 610, send information to the output module 615, or be integrated in combination with the input module 610, the output module 615, or both to receive information, transmit information, or perform various other operations as described herein.

The synthetic conversation manager 620 may support data processing in accordance with examples as disclosed herein. The reference information component 625 may be configured to support receiving first reference information associated with a set of multiple users. The synthetic conversation component 630 may be configured to support generating, using a first generative artificial intelligence (AI) model and based on the first reference information, one or more synthetic conversation records. The response pair component 635 may be configured to support generating a set of multiple response pairs based on the one or more synthetic conversation records, each response pair of the set of multiple response pairs including a respective positive response that is in accordance with the first reference information and a respective negative response that is in disaccord with the first reference information. The parameter training component 640 may be configured to support training a first set of parameters of a second generative AI model based on the set of multiple response pairs. The parameter merging component 645 may be configured to support merging the first set of parameters of the second generative AI model with a second set of parameters associated with a base model of the second generative AI model to generate a merged set of parameters. The query component 650 may be configured to support receiving a query from a user of the set of multiple users. The response component 655 may be configured to support providing, to the user, a response generated by the second generative AI model based on the merged set of parameters of the second generative AI model.

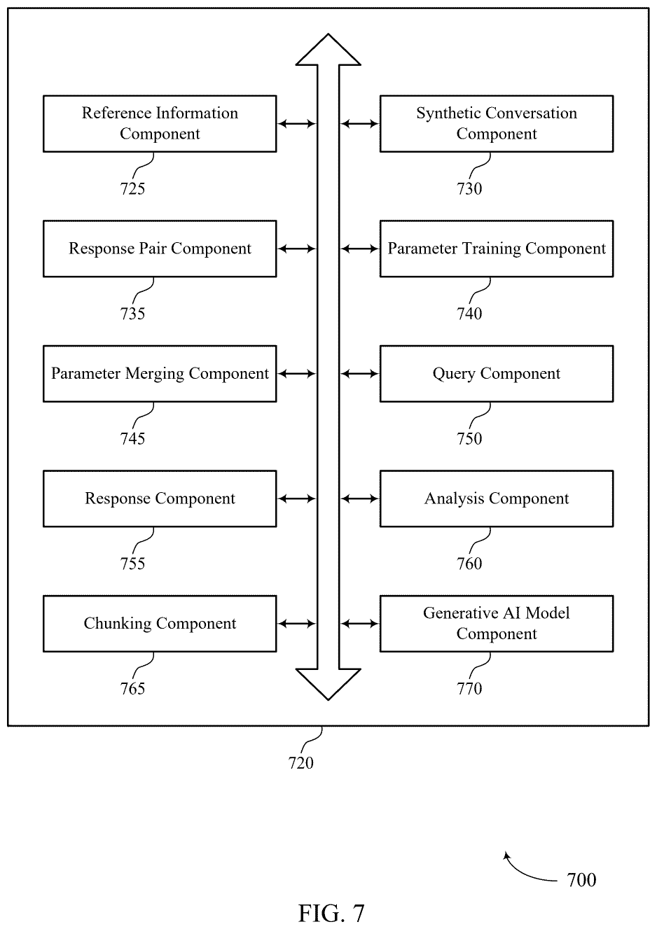

FIG. 7 shows a block diagram 700 of a synthetic conversation manager 720 that supports synthetic conversation generation for generative artificial intelligence model tuning in accordance with examples as disclosed herein. The synthetic conversation manager 720 may be an example of aspects of a synthetic conversation manager or a synthetic conversation manager 620, or both, as described herein. The synthetic conversation manager 720, or various components thereof, may be an example of means for performing various aspects of synthetic conversation generation for generative artificial intelligence model tuning as described herein. For example, the synthetic conversation manager 720 may include a reference information component 725, a synthetic conversation component 730, a response pair component 735, a parameter training component 740, a parameter merging component 745, a query component 750, a response component 755, an analysis component 760, a chunking component 765, a generative AI model component 770, or any combination thereof. Each of these components, or components of subcomponents thereof (e.g., one or more processors, one or more memories), may communicate, directly or indirectly, with one another (e.g., via one or more buses).

The synthetic conversation manager 720 may support data processing in accordance with examples as disclosed herein. The reference information component 725 may be configured to support receiving first reference information associated with a set of multiple users. The synthetic conversation component 730 may be configured to support generating, using a first generative artificial intelligence (AI) model and based on the first reference information, one or more synthetic conversation records. The response pair component 735 may be configured to support generating a set of multiple response pairs based on the one or more synthetic conversation records, each response pair of the set of multiple response pairs including a respective positive response that is in accordance with the first reference information and a respective negative response that is in disaccord with the first reference information. The parameter training component 740 may be configured to support training a first set of parameters of a second generative AI model based on the set of multiple response pairs. The parameter merging component 745 may be configured to support merging the first set of parameters of the second generative AI model with a second set of parameters associated with a base model of the second generative AI model to generate a merged set of parameters. The query component 750 may be configured to support receiving a query from a user of the set of multiple users. The response component 755 may be configured to support providing, to the user, a response generated by the second generative AI model based on the merged set of parameters of the second generative AI model.

In some examples, generating the one or more synthetic conversation records includes providing, a prompt requesting generation of the one or more synthetic conversation records to include one or more positive responses that are in accordance with the first reference information, one or more negative responses that are in conflict with the first reference information, or both. In some examples, the one or more synthetic conversation records include the one or more positive responses, the one or more negative responses, or both.

In some examples, to support generating the set of multiple response pairs, the analysis component 760 may be configured to support analyzing the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information, where the set of multiple response pairs include information from the one or more first portions.

In some examples, the correspondences between the one or more first portions and the one or more second portions include explicit correspondences in which first language in the one or more first portions is also included in the one or more second portions, implicit correspondences in which second language in the one or more first portions refers to third language in the one or more second portions, or both.

In some examples, generating the set of multiple response pairs is further based on one or more natural conversation records, feedback information associated with the one or more natural conversation records, or both.

In some examples, to support merging the first set of parameters with the second set of parameters, the parameter merging component 745 may be configured to support applying a weight update to the second set of parameters of the second generative AI model, where the weight update is based on the first set of parameters.

In some examples, the chunking component 765 may be configured to support dividing the first reference information into one or more chunks, where generating the one or more synthetic conversation records includes providing the one or more chunks of the first reference information to the first generative AI model.

In some examples, the first reference information includes reference articles, chat template responses, chat transcripts, or any combination thereof.

In some examples, the first generative AI model and the second generative AI model are a same generative AI model.

In some examples, the set of multiple users are associated with a tenant of a multi-tenant processing system.

FIG. 8 shows a diagram of a system 800 including a device 805 that supports synthetic conversation generation for generative artificial intelligence model tuning in accordance with examples as disclosed herein. The device 805 may be an example of or include components of a device 605 as described herein. The device 805 may include components for bi-directional data communications including components for transmitting and receiving communications, such as a synthetic conversation manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting synthetic conversation generation for generative artificial intelligence model tuning). The processor 830 may be an example of a single processor or multiple processors. For example, the device 805 may include one or more processors 830.

The synthetic conversation manager 820 may support data processing in accordance with examples as disclosed herein. For example, the synthetic conversation manager 820 may be configured to support receiving first reference information associated with a set of multiple users. The synthetic conversation manager 820 may be configured to support generating, using a first generative artificial intelligence (AI) model and based on the first reference information, one or more synthetic conversation records. The synthetic conversation manager 820 may be configured to support generating a set of multiple response pairs based on the one or more synthetic conversation records, each response pair of the set of multiple response pairs including a respective positive response that is in accordance with the first reference information and a respective negative response that is in disaccord with the first reference information. The synthetic conversation manager 820 may be configured to support training a first set of parameters of a second generative AI model based on the set of multiple response pairs. The synthetic conversation manager 820 may be configured to support merging the first set of parameters of the second generative AI model with a second set of parameters associated with a base model of the second generative AI model to generate a merged set of parameters. The synthetic conversation manager 820 may be configured to support receiving a query from a user of the set of multiple users. The synthetic conversation manager 820 may be configured to support providing, to the user, a response generated by the second generative AI model based on the merged set of parameters of the second generative AI model.

By including or configuring the synthetic conversation manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

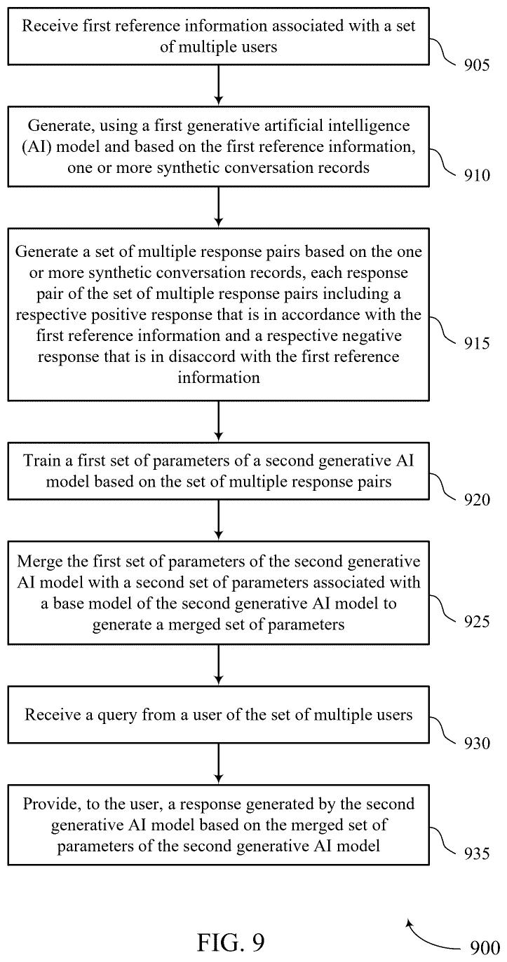

FIG. 9 shows a flowchart illustrating a method 900 that supports synthetic conversation generation for generative artificial intelligence model tuning in accordance with examples as disclosed herein. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 905, the method may include receiving first reference information associated with a set of multiple users. The operations of 905 may be performed in accordance with examples as disclosed herein. In some examples, aspects of the operations of 905 may be performed by a reference information component 725 as described with reference to FIG. 7.

At 910, the method may include generating, using a first generative artificial intelligence (AI) model and based on the first reference information, one or more synthetic conversation records. The operations of 910 may be performed in accordance with examples as disclosed herein. In some examples, aspects of the operations of 910 may be performed by a synthetic conversation component 730 as described with reference to FIG. 7.

At 915, the method may include generating a set of multiple response pairs based on the one or more synthetic conversation records, each response pair of the set of multiple response pairs including a respective positive response that is in accordance with the first reference information and a respective negative response that is in disaccord with the first reference information. The operations of 915 may be performed in accordance with examples as disclosed herein. In some examples, aspects of the operations of 915 may be performed by a response pair component 735 as described with reference to FIG. 7.

At 920, the method may include training a first set of parameters of a second generative AI model based on the set of multiple response pairs. The operations of 920 may be performed in accordance with examples as disclosed herein. In some examples, aspects of the operations of 920 may be performed by a parameter training component 740 as described with reference to FIG. 7.

At 925, the method may include merging the first set of parameters of the second generative AI model with a second set of parameters associated with a base model of the second generative AI model to generate a merged set of parameters. The operations of 925 may be performed in accordance with examples as disclosed herein. In some examples, aspects of the operations of 925 may be performed by a parameter merging component 745 as described with reference to FIG. 7.

At 930, the method may include receiving a query from a user of the set of multiple users. The operations of 930 may be performed in accordance with examples as disclosed herein. In some examples, aspects of the operations of 930 may be performed by a query component 750 as described with reference to FIG. 7.

At 935, the method may include providing, to the user, a response generated by the second generative AI model based on the merged set of parameters of the second generative AI model. The operations of 935 may be performed in accordance with examples as disclosed herein. In some examples, aspects of the operations of 935 may be performed by a response component 755 as described with reference to FIG. 7.

A method for data processing by an application server is described. The method may include receiving first reference information associated with a set of multiple users, generating, using a first generative artificial intelligence (AI) model and based on the first reference information, one or more synthetic conversation records, generating a set of multiple response pairs based on the one or more synthetic conversation records, each response pair of the set of multiple response pairs including a respective positive response that is in accordance with the first reference information and a respective negative response that is in disaccord with the first reference information, training a first set of parameters of a second generative AI model based on the set of multiple response pairs, merging the first set of parameters of the second generative AI model with a second set of parameters associated with a base model of the second generative AI model to generate a merged set of parameters, receiving a query from a user of the set of multiple users, and providing, to the user, a response generated by the second generative AI model based on the merged set of parameters of the second generative AI model.

An application server for data processing is described. The application server may include one or more memories storing processor executable code, and one or more processors coupled with the one or more memories. The one or more processors may individually or collectively be operable to execute the code to cause the application server to receive first reference information associated with a set of multiple users, generate, using a first generative artificial intelligence (AI) model and based on the first reference information, one or more synthetic conversation records, generate a set of multiple response pairs based on the one or more synthetic conversation records, each response pair of the set of multiple response pairs including a respective positive response that is in accordance with the first reference information and a respective negative response that is in disaccord with the first reference information, train a first set of parameters of a second generative AI model based on the set of multiple response pairs, merge the first set of parameters of the second generative AI model with a second set of parameters associated with a base model of the second generative AI model to generate a merged set of parameters, receive a query from a user of the set of multiple users, and provide, to the user, a response generated by the second generative AI model based on the merged set of parameters of the second generative AI model.

Another application server for data processing is described. The application server may include means for receiving first reference information associated with a set of multiple users, means for generating, using a first generative artificial intelligence (AI) model and based on the first reference information, one or more synthetic conversation records, means for generating a set of multiple response pairs based on the one or more synthetic conversation records, each response pair of the set of multiple response pairs including a respective positive response that is in accordance with the first reference information and a respective negative response that is in disaccord with the first reference information, means for training a first set of parameters of a second generative AI model based on the set of multiple response pairs, means for merging the first set of parameters of the second generative AI model with a second set of parameters associated with a base model of the second generative AI model to generate a merged set of parameters, means for receiving a query from a user of the set of multiple users, and means for providing, to the user, a response generated by the second generative AI model based on the merged set of parameters of the second generative AI model.

A non-transitory computer-readable medium storing code for data processing is described. The code may include instructions executable by one or more processors to receive first reference information associated with a set of multiple users, generate, using a first generative artificial intelligence (AI) model and based on the first reference information, one or more synthetic conversation records, generate a set of multiple response pairs based on the one or more synthetic conversation records, each response pair of the set of multiple response pairs including a respective positive response that is in accordance with the first reference information and a respective negative response that is in disaccord with the first reference information, train a first set of parameters of a second generative AI model based on the set of multiple response pairs, merge the first set of parameters of the second generative AI model with a second set of parameters associated with a base model of the second generative AI model to generate a merged set of parameters, receive a query from a user of the set of multiple users, and provide, to the user, a response generated by the second generative AI model based on the merged set of parameters of the second generative AI model.

Some examples of the method, application servers, and non-transitory computer-readable medium described herein may further include operations, features, means, or instructions for generating the one or more synthetic conversation records includes providing, a prompt requesting generation of the one or more synthetic conversation records to include one or more positive responses that may be in accordance with the first reference information, one or more negative responses that may be in conflict with the first reference information, or both and the one or more synthetic conversation records include the one or more positive responses, the one or more negative responses, or both.

In some examples of the method, application servers, and non-transitory computer-readable medium described herein, generating the set of multiple response pairs may include operations, features, means, or instructions for analyzing the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information, where the set of multiple response pairs include information from the one or more first portions.

In some examples of the method, application servers, and non-transitory computer-readable medium described herein, the correspondences between the one or more first portions and the one or more second portions include explicit correspondences in which first language in the one or more first portions may be also included in the one or more second portions, implicit correspondences in which second language in the one or more first portions refers to third language in the one or more second portions, or both.

Some examples of the method, application servers, and non-transitory computer-readable medium described herein may further include operations, features, means, or instructions for generating the set of multiple response pairs may be further based on one or more natural conversation records, feedback information associated with the one or more natural conversation records, or both.

In some examples of the method, application servers, and non-transitory computer-readable medium described herein, merging the first set of parameters with the second set of parameters may include operations, features, means, or instructions for applying a weight update to the second set of parameters of the second generative AI model, where the weight update may be based on the first set of parameters.

Some examples of the method, application servers, and non-transitory computer-readable medium described herein may further include operations, features, means, or instructions for dividing the first reference information into one or more chunks, where generating the one or more synthetic conversation records includes providing the one or more chunks of the first reference information to the first generative AI model.

In some examples of the method, application servers, and non-transitory computer-readable medium described herein, the first reference information includes reference articles, chat template responses, chat transcripts, or any combination thereof.

In some examples of the method, application servers, and non-transitory computer-readable medium described herein, the first generative AI model and the second generative AI model may be a same generative AI model.

In some examples of the method, application servers, and non-transitory computer-readable medium described herein, the set of multiple users may be associated with a tenant of a multi-tenant processing system.

The following provides an overview of aspects of the present disclosure:

Aspect 1: A method for data processing at an application server, comprising: receiving first reference information associated with a plurality of users; generating, using a first generative artificial intelligence (AI) model and based at least in part on the first reference information, one or more synthetic conversation records; generating a plurality of response pairs based at least in part on the one or more synthetic conversation records, each response pair of the plurality of response pairs comprising a respective positive response that is in accordance with the first reference information and a respective negative response that is in disaccord with the first reference information; training a first set of parameters of a second generative AI model based at least in part on the plurality of response pairs; merging the first set of parameters of the second generative AI model with a second set of parameters associated with a base model of the second generative AI model to generate a merged set of parameters; receiving a query from a user of the plurality of users; and providing, to the user, a response generated by the second generative AI model based at least in part on the merged set of parameters of the second generative AI model.

Aspect 2: The method of aspect 1, wherein generating the one or more synthetic conversation records comprises providing, a prompt requesting generation of the one or more synthetic conversation records to include one or more positive responses that are in accordance with the first reference information, one or more negative responses that are in conflict with the first reference information, or both; and the one or more synthetic conversation records comprise the one or more positive responses, the one or more negative responses, or both.

Aspect 3: The method of any of aspects 1 through 2, wherein generating the plurality of response pairs further comprises: analyzing the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information, wherein the plurality of response pairs comprise information from the one or more first portions.

Aspect 4: The method of aspect 3, wherein the correspondences between the one or more first portions and the one or more second portions comprise explicit correspondences in which first language in the one or more first portions is also comprised in the one or more second portions, implicit correspondences in which second language in the one or more first portions refers to third language in the one or more second portions, or both.

Aspect 5: The method of any of aspects 1 through 4, wherein generating the plurality of response pairs is further based at least in part on one or more natural conversation records, feedback information associated with the one or more natural conversation records, or both.

Aspect 6: The method of any of aspects 1 through 5, wherein merging the first set of parameters with the second set of parameters comprises: applying a weight update to the second set of parameters of the second generative AI model, wherein the weight update is based at least in part on the first set of parameters.

Aspect 7: The method of any of aspects 1 through 6, further comprising: dividing the first reference information into one or more chunks, wherein generating the one or more synthetic conversation records comprises providing the one or more chunks of the first reference information to the first generative AI model.

Aspect 8: The method of any of aspects 1 through 7, wherein the first reference information comprises reference articles, chat template responses, chat transcripts, or any combination thereof.

Aspect 9: The method of any of aspects 1 through 8, wherein the first generative AI model and the second generative AI model are a same generative AI model.

Aspect 10: The method of any of aspects 1 through 9, wherein the plurality of users are associated with a tenant of a multi-tenant processing system.

Aspect 11: An application server for data processing, comprising one or more memories storing processor-executable code, and one or more processors coupled with the one or more memories and individually or collectively operable to execute the code to cause the application server to perform a method of any of aspects 1 through 10.

Aspect 12: An application server for data processing, comprising at least one means for performing a method of any of aspects 1 through 10.

Aspect 13: A non-transitory computer-readable medium storing code for data processing, the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
receiving first reference information associated with a plurality of users;
generating, using a first generative artificial intelligence (AI) model and based at least in part on the first reference information, one or more synthetic conversation records;
generating a plurality of response pairs based at least in part on the one or more synthetic conversation records, each response pair of the plurality of response pairs comprising a respective positive response that is in accordance with the first reference information and a respective negative response that is in disaccord with the first reference information;
training a first set of parameters of a second generative AI model based at least in part on the plurality of response pairs;
merging the first set of parameters of the second generative AI model with a second set of parameters associated with a base model of the second generative AI model to generate a merged set of parameters;
receiving a query from a user of the plurality of users; and
providing, to the user, a response generated by the second generative AI model based at least in part on the merged set of parameters of the second generative AI model.

2. The method of claim 1, wherein:
generating the one or more synthetic conversation records comprises providing, a prompt requesting generation of the one or more synthetic conversation records to include one or more positive responses that are in accordance with the first reference information, one or more negative responses that are in conflict with the first reference information, or both; and
the one or more synthetic conversation records comprise the one or more positive responses, the one or more negative responses, or both.

3. The method of claim 1, wherein generating the plurality of response pairs further comprises:
analyzing the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information, wherein the plurality of response pairs comprise information from the one or more first portions.

4. The method of claim 3, wherein the correspondences between the one or more first portions and the one or more second portions comprise explicit correspondences in which first language in the one or more first portions is also comprised in the one or more second portions, implicit correspondences in which second language in the one or more first portions refers to third language in the one or more second portions, or both.

5. The method of claim 1, wherein generating the plurality of response pairs is further based at least in part on one or more natural conversation records, feedback information associated with the one or more natural conversation records, or both.

6. The method of claim 1, wherein merging the first set of parameters with the second set of parameters comprises:
applying a weight update to the second set of parameters of the second generative AI model, wherein the weight update is based at least in part on the first set of parameters.

7. The method of claim 1, further comprising:
dividing the first reference information into one or more chunks, wherein generating the one or more synthetic conversation records comprises providing the one or more chunks of the first reference information to the first generative AI model.

8. The method of claim 1, wherein the first reference information comprises reference articles, chat template responses, chat transcripts, or any combination thereof.

9. The method of claim 1, wherein the first generative AI model and the second generative AI model are a same generative AI model.

10. The method of claim 1, wherein the plurality of users are associated with a tenant of a multi-tenant processing system.

11. An application server for data processing, comprising:
one or more memories storing processor-executable code; and
one or more processors coupled with the one or more memories and individually or collectively operable to execute the code to cause the application server to:
receive first reference information associated with a plurality of users;
generate, using a first generative artificial intelligence (AI) model and based at least in part on the first reference information, one or more synthetic conversation records;
generate a plurality of response pairs based at least in part on the one or more synthetic conversation records, each response pair of the plurality of response pairs comprising a respective positive response that is in accordance with the first reference information and a respective negative response that is in disaccord with the first reference information;
train a first set of parameters of a second generative AI model based at least in part on the plurality of response pairs;
merge the first set of parameters of the second generative AI model with a second set of parameters associated with a base model of the second generative AI model to generate a merged set of parameters;
receive a query from a user of the plurality of users; and
provide, to the user, a response generated by the second generative AI model based at least in part on the merged set of parameters of the second generative AI model.

12. The application server of claim 11, wherein:
to generate the one or more synthetic conversation records, the one or more processors are individually or collectively further operable to execute the code to cause the application server to provide a prompt requesting generation of the one or more synthetic conversation records to include one or more positive responses that are in accordance with the first reference information, one or more negative responses that are in conflict with the first reference information, or both; and
the one or more synthetic conversation records comprise the one or more positive responses, the one or more negative responses, or both.

13. The application server of claim 11, wherein, to generate the plurality of response pairs, the one or more processors are individually or collectively further operable to execute the code to cause the application server to:
analyze the one or more synthetic conversation records, one or more natural conversation records, feedback information associated with the one or more natural conversation records, or any combination thereof, to determine one or more first portions of the one or more synthetic conversation records, the one or more natural conversation records, or both, that correspond with one or more second portions of the first reference information, wherein the plurality of response pairs comprise information from the one or more first portions.

14. The application server of claim 11, wherein generating the plurality of response pairs is further based at least in part on one or more natural conversation records, feedback information associated with the one or more natural conversation records, or both.

15. The application server of claim 11, wherein, to merge the first set of parameters with the second set of parameters, the one or more processors are individually or collectively operable to execute the code to cause the application server to:
apply a weight update to the second set of parameters of the second generative AI model, wherein the weight update is based at least in part on the first set of parameters.

16. The application server of claim 11, wherein the one or more processors are individually or collectively further operable to execute the code to cause the application server to:
divide the first reference information into one or more chunks, wherein generating the one or more synthetic conversation records comprises providing the one or more chunks of the first reference information to the first generative AI model.

17. The application server of claim 11, wherein the first reference information comprises reference articles, chat template responses, chat transcripts, or any combination thereof.

18. The application server of claim 11, wherein the first generative AI model and the second generative AI model are a same generative AI model.

19. The application server of claim 11, wherein the plurality of users are associated with a tenant of a multi-tenant processing system.

20. A non-transitory computer-readable medium storing code for data processing, the code comprising instructions executable by one or more processors to:
receive first reference information associated with a plurality of users;
generate, using a first generative artificial intelligence (AI) model and based at least in part on the first reference information, one or more synthetic conversation records;
generate a plurality of response pairs based at least in part on the one or more synthetic conversation records, each response pair of the plurality of response pairs comprising a respective positive response that is in accordance with the first reference information and a respective negative response that is in disaccord with the first reference information;
train a first set of parameters of a second generative AI model based at least in part on the plurality of response pairs;
merge the first set of parameters of the second generative AI model with a second set of parameters associated with a base model of the second generative AI model to generate a merged set of parameters;
receive a query from a user of the plurality of users; and
provide, to the user, a response generated by the second generative AI model based at least in part on the merged set of parameters of the second generative AI model.
